(19) United States
(12) Patent Application Publication
(10) Pub. No.: US 2023/0147466 A1
(43) Pub. Date: May 11, 2023

(54) METHOD FOR SYNCHRONIZING A SIGNAL COMPRISING A PLURALITY OF CHIRPS, AND CORRESPONDING COMPUTER PROGRAM PRODUCT AND DEVICE

(71) Applicants: UNIVERSITE DE BORDEAUX, BORDEAUX (FR); INSTITUT POLYTECHNIQUE DE BORDEAUX, TALENCE Cedex (FR); CENTRE NATIONAL DE LA RECHERCHE SCIENTIFIQUE, PARIS (FR)

(72) Inventors: Guillaume FERRE, Gradignan (FR); Mohamed Amine BEN TEMIN, Talence (FR)

(21) Appl. No.: 17/915,439

(22) PCT Filed: Apr. 23, 2021
(86) PCT No.: PCT/FR2021/050705

§ 371 Date: Sep. 28, 2022

(30) Foreign Application Priority Data
Apr. 23, 2020 (FR) 2004077

(51) Int. Cl. H04B 1/69; H04L 7/04

(52) U.S. Cl. CPC H04B 1/69; H04L 7/04; H04B 2001/6912

(57) ABSTRACT

A method for synchronizing a signal having modulated chirps. The modulation corresponds to circular permutation of the pattern of variation in the instantaneous frequency of a chirp over the symbol time. For a portion of the signal that is representative of at least one chirp, estimating a first piece of time synchronization information representative of a time shift in the signal relative to a given time reference. Using the first piece of time synchronization information, a piece of fractional frequency synchronization information is estimated, that is representative of a frequency shift in the signal relative to a given frequency reference modulo the inverse of the symbol time. Using the piece of fractional frequency synchronization information, second time synchronization information is estimated, representative of a time shift in the signal relative to the given time reference.

### FIELD OF THE INVENTION

The field of the invention is that of transmitting data via the use of a waveform referred to as “chirp”.

The invention relates more particularly to a method for synchronizing such a waveform.

Such a waveform is used for the transmission of data via communication links of different types, e.g., acoustic, radiofrequency, etc. For example, the LoRa® technology dedicated to the low consumption transmission by the connected objects via a radiofrequency link uses such a waveform. The invention thus has applications, in particular, but not exclusively, in all the areas of personal and professional life wherein the connected objects are present. This concerns for example the fields of health, sport, domestic applications (security, household appliances, etc.), object tracking, etc.

### BACKGROUND OF THE INVENTION

Interest is more particularly given in the rest of this document to describing an existing problem in the field of connected objects wherein the LoRa® technology is for example used and to which the inventors of this patent application were confronted. The invention is of course not limited to this particular field of application, but has an interest in the processing of any communication signal based on the use of a waveform referred to as “chirp”.

Presented as the “third revolution of the Internet”, connected objects are imposing themselves in all areas of daily life and of the company. Most of these objects are intended to produce data thanks to their built-in sensors so as to provide value-added services for their owner.

Due to the target applications, these connected objects are for the most part mobile. In particular, they must be able to transmit the data produced, regularly or on demand, to an offset user.

To do this, long-range radio transmission of the cellular mobile radio type (2G/3G/4G . . . ) was a technology of choice. This technology indeed made it possible to benefit from network coverage in most countries.

However, the mobile aspect of these objects is often accompanied by a need for autonomy in energy. Yet, even based on one of the most energy-saving cellular mobile radio technologies, the current connected objects continue to have a consumption that is prohibitive in allowing for large-scale deployment at a reasonable cost.

Faced with the problem of the consumption of the radio link for such mobile applications, new low consumption and low speed radio technologies dedicated specifically to the “Internet of Things” networks, i.e., radio technologies for networks referred to as LPWAN (for “Low-Power Wide-Area Networks”), are developed.

In practice, two sorts of technologies can be distinguished:
on the one hand, there are proprietary technologies such as for example the technology from the Sigfox® company, or the LoRa® technology, or the technology from the Qowisio® company. These non-standardized technologies are all based on the use of the “Industrial, Scientific and Medical” frequency band, referred to as ISM, and on the regulations associated with the use thereof. The interest with these technologies is that they are already available and allow for rapid deployment of networks on a limit investment basis. Furthermore, they allow for the development of connected objects that save a substantial amount of energy and at a low cost
on the other hand, there are several technologies promoted by standardization bodies. As an example, mention can be made of three standardized technologies with 3GPP (for “3rd Generation Partnership Project”): NB-IoT (for “Narrow Band-Internet of Things”), LTE MTC (for “Long Term Evolution-Machine Type Communication”) and EC-GSM-IoT (for “Extended Coverage-GSM-Internet of Things”). Such solutions are based on the use of licensed frequency bands but can also be used over non-licensed frequency bands.

Certain telecommunications operators have already taken an interest in the LoRa® technology to deploy their network dedicated to connected objects. For example, patent EP 2 449 690 B1 describes a technique for transmitting information, on which the LoRa® technology is based.

However, the initial feedback shows user experiences that are not very satisfactory linked to limited performance of the radio link in actual conditions. In particular, the modulation used appears to be sensitive to the synchronization of the receiver, in particular to the time synchronization. However, such a time synchronization must remain precise even in the presence of a frequency shift, e.g., between the carrier frequency of the received signal and the local oscillator generating the signal used for the transposition in frequency of the received signal. In this way, the synchronization of such a waveform often requires the implementation of a joint estimation of the time and frequency synchronization parameters, which can require a substantial calculation load. Patent document US 2014/064337 A1 implements for example a known method based on correlation in order to obtain such synchronization information.

There thus exists a need for a synchronization technique having a reduced calculation load and making it possible to estimate the time synchronization parameters precisely without there being a need to precisely estimate all the frequency synchronization parameters. Moreover, the time synchronization parameters have to be estimated precisely even in the presence of frequency desynchronization.

### OBJECT AND SUMMARY OF THE INVENTION

In an embodiment of the invention, a method is proposed for synchronizing a signal received by a communication receiver from the estimation of at least one piece of synchronization information of the signal. The signal comprises a plurality of chirps among M chirps. An s-th chirp among the M chirps is associated with a modulation symbol of rank s of the constellation of M symbols, s being an integer from 0 to M−1. The s-th chirp is the result of a modulation of a basic chirp of which an instantaneous frequency varies between a first instantaneous frequency and a second instantaneous frequency during a symbol time T. The modulation corresponds, for the modulation symbol of rank s, to a circular permutation of the variation pattern of the instantaneous frequency over the symbol time T, obtained by a time shift of s times an elementary time duration Tc, such that M*Tc=T. Such a method comprises, for a portion of the signal that is representative of at least one chirp of the plurality of chirps, the following steps implemented by a device for synchronizing (for example included in the communication receiver):
an estimation of a first piece of time synchronization information representative of a time shift in the signal relative to a given time reference
an estimation, using the first piece of time synchronization information of a piece of fractional frequency synchronization information that is representative of a frequency shift in the signal relative to a given frequency reference modulo the inverse of the symbol time T; and
an estimation, implementing the piece of fractional frequency synchronization information, of at least one second piece of time synchronization information representative of a time shift in the signal relative to the given time reference.
   The portion of the signal comprises a plurality of successive elementary portions of duration T starting at an instant according to the first piece of time synchronization information. For at least one pair of successive elementary portions of the plurality, the estimation of the piece of fractional frequency synchronization information implements the calculation of a phase, referred to as correlation phase, of a correlation value between, on the one hand, the signal considered on one of the elementary portions of the pair and, on the other hand, the signal considered on the other of the elementary portions of the pair, the piece of fractional frequency synchronization information being according to the correlation phase. The estimation of said at least one second piece of time synchronization information comprises a derotation of the portion of the signal according to the piece of fractional frequency synchronization information delivering a portion of the signal partially resynchronized in frequency.

Thus, the invention proposes a new and inventive solution for estimating the time synchronization parameters without there being a need to precisely estimate all the frequency synchronization parameters. Indeed, only the fractional portion of the frequency shift of the signal relative to a given frequency reference considered (e.g., the frequency of a radiofrequency synthesizer generating a carrier used for the transposition in frequency of the signal considered, or the frequency of a reference clock, etc.) is used here so as to refine the first estimation of the time shift of the signal relative to the given time reference considered (e.g., a given edge (rising or falling) of a reference clock, of a sampling clock of the signal, etc.). In other terms, the time synchronization parameters are estimated without taking account of the complete portion of the frequency shift of the signal relative to the given frequency reference (i.e., the complete portion of a ratio between, on the one hand, the frequency shift in question and, on the other hand, the inverse of the symbol time T).

However, the taking into account of this single fractional portion of the frequency shift of the signal relative to the given frequency reference makes it possible to obtain a precise estimation of the time shift even in the presence of a substantial frequency shift.

Moreover, the fractional portion of the frequency shift of the signal relative to the frequency reference considered is estimated via the detection of at least two successive chirps having the same variation in phase (i.e., chirps all having an instantaneous frequency with a positive slope or chirps all having an instantaneous frequency with a negative slope) via the calculation of the correlation phase. This concerns for example identical successive chirps of a training or synchronization word as can be found for example in the radio frames according to the LoRa® protocol.

According to an embodiment, the estimation of said at least one second piece of time synchronization information comprises an estimation, using the piece of fractional frequency synchronization information, a second piece of fractional time synchronization information representative of a time shift in the signal relative to the given time reference modulo the symbol time T.

Thus, the estimation of the fractional portion of the time shift of the signal relative to the given time reference is refined by the taking into account of the fractional portion of the frequency shift of the signal.

According to an embodiment, the estimation of said at least one second piece of time synchronization information comprises an estimation, implementing the piece of fractional frequency synchronization information and the second piece of fractional time synchronization information of a complete piece of time synchronization information that is representative of a complete portion of a ratio between, on the one hand, the time shift and, on the other hand, the symbol time T.

Thus, the estimation of the complete portion of the time shift of the signal relative to the given time reference is refined by the taking into account of the fractional portion of the time shift and of the fractional portion of the frequency shift of the signal.

According to an embodiment, the plurality of successive elementary portions of duration T comprises at least three elementary portions. For each pair of successive elementary portions among said at least three portions, the estimation of the piece of fractional frequency synchronization information implements the calculation of the correlation phase delivering a corresponding set of correlation phases. The piece of fractional frequency synchronization information is according to an average of the phases of the set of correlation phases.

Thus, the estimation of the fractional portion of the frequency shift of the signal relative to the frequency reference considered is refined via the average over different successive chirps all having the same variation in phase (e.g., identical successive chirps of a training or synchronization word).

According to an embodiment, the estimation of the second piece of fractional time synchronization information comprises, for at least one sequence of samples of the portion partially resynchronized in frequency corresponding to an elementary portion of duration T of the portion of the signal starting at an instant according to the first piece of time synchronization information:
an element-wise multiplication between, on the one hand, the sequence of samples of the portion partially resynchronized in frequency and, on the other hand, a sequence of samples that is representative of a conjugated reference chirp obtained by application of the modulation to a conjugated basic chirp an instantaneous frequency of which varies between the second instantaneous frequency and the first instantaneous frequency during the symbol time T, the multiplication delivering a sequence of multiple samples; and
a Fourier transform of the sequence of multiplied samples delivering a sequence of transformed multiplied samples.

the second piece of fractional time synchronization information is according to a sample of stronger amplitude among the transformed multiplied samples.

Thus, the estimation of the fractional portion of the time shift of the signal relative to the given time reference is refined via the detecting of at least one expected reference chirp (e.g., a chirp of a training or synchronization word) in the signal partially resynchronized in frequency.

According to an embodiment, the estimation of the second piece of fractional time synchronization information implements a method for a dichotomy search of a frequency index maximizing an interpolated function from transformed multiplied samples.

Thus, the estimation of the fractional portion of the time shift of the signal is done with a time resolution that is finer than the sampling period of the transformed multiplied samples at the output of the Fourier transform.

According to an embodiment, the multiplication and the Fourier transform are implemented for a plurality of sequences of successive samples of the portion partially resynchronized in frequency each corresponding to an elementary portion of duration T of the portion of the signal starting at an instant according to the first piece of time synchronization information delivering at least one corresponding plurality of sequences of transformed multiplied samples. The dichotomy search is implemented for each sequence of transformed multiplied samples of the plurality of sequences of transformed multiplied samples and delivers a plurality of corresponding frequency indexes. The second piece of fractional time synchronization information is according to an average of the frequency indexes of the plurality of time indexes.

Thus, contrary to the case where reference chirps having opposite instantaneous frequency variations (i.e., an instantaneous frequency with positive and negative slopes) are required to allow for a good estimation of the synchronization parameters, here only successive reference chips having the same variation in phase are required to implement the present technique. A reduction in the length of the training word can then be considered, thereby improving the spectral efficiency of the communication system.

According to an embodiment, then estimation of the second piece of complete time synchronization information comprises a time translation of the portion partially resynchronized in frequency according to the second piece of fractional time synchronization information delivering a portion of the signal partially resynchronized in frequency and in time.

Thus, the fractional portion of the time shift as well as the fractional portion of the frequency shift of the signal relative to the corresponding references are taken into account to refine the estimation of the complete portion of the time shift.

According to an embodiment, the estimation of the second piece of complete time synchronization information comprises a dichotomy search that is iterative over a time search interval that is updated at each iteration. The dichotomy search implements, for a given iteration corresponding to a given time search interval:
a first Fourier transform of a sequence of samples of the portion partially resynchronized in frequency and in time corresponding to an elementary portion of duration T of the portion of the signal starting at a first instant according to a first limit of the given time search interval and of the first piece of time synchronization information. The first Fourier transform delivers a first sequence of transformed samples; and
a second Fourier transform of a sequence of samples of the portion partially resynchronized in frequency and in time corresponding to an elementary portion of duration T of the portion of the signal starting at a second instant according to a second limit of the given time search interval and of the first piece of time synchronization information. The second Fourier transform delivers a second sequence of transformed samples.

The given iteration delivers a time search interval updated according to the given time search interval and an extreme value among the first and second sequences of transformed samples. The dichotomy search implements for a predetermined number of iterations delivers a final time search interval. The second piece of complete time synchronization information is according to at least one limit of the final time search interval.

Thus, the estimation of the complete portion of the time shift of the signal relative to the time reference considered is refined simply and robustly.

According to an embodiment, the predetermined number of iterations is according to an initial time search interval and an estimation tolerance over the second piece of complete time synchronization information.

The invention also relates to a computer program comprising program code instructions for the implementation of a method such as described hereinabove, according to any of its different embodiments, when it is executed on a computer.

In an embodiment of the invention, a device for synchronizing is proposed. Such a device for synchronizing comprises a reprogrammable calculation machine or a dedicated calculation machine configured to implement the steps of the method for synchronizing according to the invention (according to any of the aforementioned different embodiments). Thus, the characteristics and advantages of this device are the same as those of the corresponding steps of the method for synchronizing described hereinabove. Consequently, they are not described in any further detail.

### BRIEF DESCRIPTION OF THE FIGURES

Other purposes, characteristics and advantages of the invention shall appear more clearly when reading the following description, given as a simple illustrative and non-limited example, in relation with the figures, among which:

FIG. 1 shows an object connected to a base station of a radiocommunication network of the low speed and low consumption type according to an embodiment of the invention;

FIG. 2A shows the instantaneous frequency of a basic chirp;

FIG. 2b shows the modulation of the basic chirp of FIG. 2A via a circular permutation of the variation pattern of its instantaneous frequency;

FIG. 2c shows the instantaneous frequency of the chirp resulting from the modulation of the basic chirp of FIG. 2A via the circular permutation shown in FIG. 2B;

FIG. 3 shows the steps of a method for synchronizing a signal comprising a plurality of chirps according to an embodiment of the invention; and

FIG. 4 shows an example of the device structure allowing for the implementation of the steps of the method for synchronizing of FIG. 3 according to an embodiment of the invention.

### DETAILED DESCRIPTION OF EMBODIMENTS OF THE INVENTION

The main principle of the invention is based on the estimation of a first piece of time synchronization information of a signal comprising a plurality of chirps each one modulated by a modulation symbol over a duration equal to the symbol time T. From the first piece of time synchronization information, a piece of fractional frequency synchronization information that is representative of a frequency shift in the signal relative to a given frequency reference modulo the inverse of the symbol time T is estimated. A second piece of time synchronization information of the signal is estimated by implementing the piece of fractional frequency synchronization information. The second piece of time synchronization information is more precise than the first piece of time synchronization information through the taking into account of the fractional portion of the frequency shift. Such an improvement in the precision of the time synchronization parameters is thus obtained even in the presence of a frequency shift even when all the frequency synchronization parameters have not been estimated. In particular, the second piece of time synchronization information is estimated without implementing the complete portion of the frequency shift of the signal relative to the frequency reference considered (i.e. the complete portion of a ratio between, on the one hand, the frequency shift in question and, on the other hand, the inverse of the symbol time T).

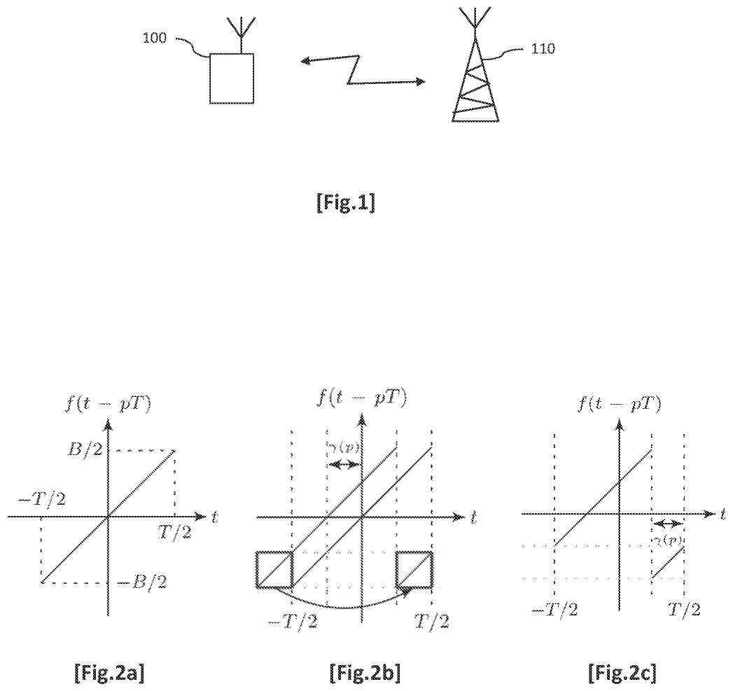

FIG. 1 shows an object 100 connected to a base station 110 of a radiocommunication network of the low speed and low consumption type according to an embodiment of the invention. More particularly, the radiocommunication network implements the LoRa® communication protocol. However, in other embodiments, other communication protocols implementing a waveform referred to as “chirp” such as described hereinbelow are considered.

In relation with FIG. 2A, FIG. 2B and FIG. 2C, the modulation of a basic chirp via a circular permutation of the variation pattern of its instantaneous frequency is now presented.

A basic chirp is defined as the chirp from which are obtained the other chirps used for the transmission of the information following the modulation process by the modulation symbols.

More particularly, the instantaneous phase (i.e., the phase of the complex envelope representing the chirp in question) of the basic chirp is expressed for t in the interval

$$[ - \frac{T}{2} , \frac{T}{2} )$$

### (FIG. 2A) as

$$ϕ ( t ) = 2 π \frac{B}{2 T} {( t )}^{2}$$

with:
T: the symbol duration (also called signaling interval for example in the LoRa® standard);
B=2^{SF}/T: the bandwidth of the signal, with SF the spreading factor or number of bits per symbol. M=2^{SF} is thus the total number of symbols in the constellation of modulation symbols.

Based on these notations, the instantaneous frequency f(t) of the basic chirp, which corresponds to the derivative of the instantaneous phase ϕ(t), is expressed as

$$f ( t ) = \frac{B}{T} t .$$

The instantaneous frequency f(t) is thus linked to the angular rotation speed in the complex plane of the vector the coordinates of which are given by the in-phase and quadrature phase signals representing the modulating signal (i.e., the real and imaginary portions of the complex envelope in practice) intended to modulate the radiofrequency carrier in such a way as to transpose the basic chirp signal over a carrier frequency.

The instantaneous frequency f(t) of the basic chirp shown in FIG. 2a is linear over time, i.e., varies linearly between a first instantaneous frequency, here −B/2, and a second instantaneous frequency, here +B/2, during the duration T of a symbol. Indeed, a chirp having a linear instantaneous frequency is used as a basic chirp (also called “raw” chirp) in the LoRa® standard.

In other embodiments, other types of basic chirps are considered, for example basic chirps the instantaneous frequency of which has a negative slope, or the instantaneous frequency of which does not vary linearly over time.

Returning to FIG. 2A, FIG. 2B and FIG. 2C, the modulation of a chirp corresponds, for a modulation symbol of rank s, to a circular permutation of the variation pattern of said instantaneous frequency over said symbol time T, obtained by a time shift of s times an elementary time duration Tc, such that M*Tc=T.

More particularly, it is possible to note fₚ(t−pT) as being the instantaneous frequency of the chirp transmitted by the connected object 100 over the time interval

$$[ pT - \frac{T}{2} , pT + \frac{T}{2} ] .$$

The instantaneous frequency of the chirp in question is obtained by time shift of a duration of

$$γ ( p ) = \frac{m ( p )}{R}$$

and circular permutation as shown in FIG. 2b and FIG. 2c. Here, is an integer between 0 and M−1 that represents the modulation symbol conveyed by the chirp transmitted by the connected object 100 over the time interval

$$[ pT - \frac{T}{2} , pT + \frac{T}{2} ] .$$

In this way, fₚ(t−pT) is expressed as the derivative of the instantaneous phase ϕₚ(t−pT):

$${f}_{p} ( t - pT ) = \frac{1}{2 π} \frac{d {ϕ}_{p} ( t - pT )}{dt} . \qquad ( Equation 1 )$$

The following is thus obtained over the time interval

$$[ pT - \frac{T}{2} , pT + \frac{T}{2} - γ ( p ) ) :$$

$${ϕ}_{p} ( t - pT ) = 2 π [ \frac{B}{2 T} {t}^{2} + \frac{m ( p )}{T} t ] .$$

And over the time interval

$$[ pT + \frac{T}{2} - γ ( p ) , pT + \frac{T}{2} {[}_{∶}$$

$${ϕ}_{p} ( t - pT ) = 2 π [ \frac{B}{2 T} {t}^{2} + ( \frac{m ( p )}{T} - B ) t ] \qquad ( Equation 3 )$$

Thus, if x(t) denotes the complex envelope of the signal including P chirps transmitted by the connected object 100, there is:

$$x ( t ) = {{\sum }_{p = 0}}^{P - 1} {e}^{j {ϕ}_{p} ( t - pT )} \qquad ( Equation 4 )$$

Moreover, the signal transmitted by the object 100 follows the frame structure defined by the LoRa® standard. In order to simplify the writings, it is supposed in what follows that the signal transmitted by the object 100 comprises a training word sₚ(t) (or synchronization word) of duration Tₚ positioned upstream of the useful data. This hypothesis does not remove any generality from the problem addressed in the present application. By noting as ϕᵣ(t) the phase trajectory of the reference chirps that comprise the training word, the complex envelope of the transmitted signal s(t) is then written:

$$s ( t ) = {{\sum }_{p = 0}}^{{N}_{p} - 1} {e}^{{jϕ}_{r} ( t - pT )} + x ( t - {N}_{p} T - {T}_{si} ) \qquad ( Equation 5 )$$

With Tₛᵢ a retaining interval between the end of the chirps of the training word and the beginning of the chirps conveying the useful data. Here, there is therefore Tₚ=NₚT+Tₛᵢ.

Thus, the signal received by a communication receiver at the base station 110 is expressed, after sampling at the frequency 1/Ts:

[symbol]

(n)=h(n)s(n−Δn)e^{j(πnT}^{ₛ}^{f}^{_{d}}^{(nT}^{ₛ}^{)+ϕ}^{_{d}}⁾+w(n) (Equation 6)

### With:

$$Δ n = ⌊ \frac{Δ t}{{T}_{s}} ⌋ ,$$

where Δt=KT+Δτ with K∈ [symbol] and

$$Δτ ∈ [ - \frac{T}{2} , \frac{T}{2} )$$

represents the time desynchronization of the signal received;
f_{d}(nTₛ) is the Doppler frequency and ϕ_{d} the phase at the origin linked to the Doppler frequency. With no loss of generality, it is supposed that f_{d}(nTₛ) also contains and frequency shift residue coming from a difference between local oscillators used to generate the emission and reception carrier frequencies;
h(n) is the pulse response of the propagation channel;
w(n) is the noise seen from the receiver, assumed to be white additive and Gaussian.

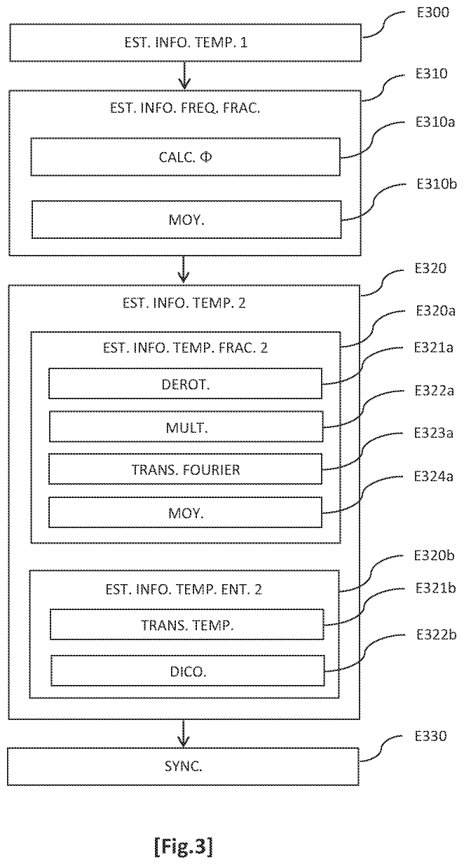

In relation with FIG. 3, the steps are now presented of a method for synchronizing according to an embodiment of the invention. More particularly, the signal [symbol] (n) the expression of which is given by the equation 6 is taken as an application example of the steps of the present method for synchronizing.

### Estimating a First Piece of Time Synchronization Information:

During a step E300, a first piece of time synchronization information that is representative of a time shift of the signal [symbol] (n) relative to a given time reference is estimated. For example, the give time reference is a predetermined sampling instant. The time shift is for example representative of the shift between the beginning of the training word of the signal [symbol] (n) and the predetermined sampling instant.

To estimate the first piece of time synchronization information, the receiver continuously multiplies each block of N=T/Ts samples by the conjugated complex of the reference chirp that comprises the expected training word. Then a Fourier transform over N points is calculated on each block of N=T/Ts samples.

For the p-th block of N=T/Ts samples, the following N transformed samples are thus obtained:

$$Y ( k , p ) = \frac{1}{\sqrt{N}} {{\sum }_{n = 0}}^{N - 1} ( y ( n , p ) {e}^{- j {ϕ}_{r} ( {nT}_{s} - pT )} ) \text{?}$$

$$With k ∈ \text{?} 0 , N - 1 \text{?} and y ( n , p ) = y ( n ) ∀ n ∈ \text{?} pN , ( p + 1 ) N - 1 \text{?} .$$

$$\text{?} \text{indicates text missing or illegible when filed}$$

More particularly, the detecting of the beginning of the preamble of the frame transmitted by the object 100 implements an averaging according to the transformed samples. For example, the detecting of the beginning of the training word of the frame implements an averaging according to the squared modulus of the transformed sequence of samples given by the equation 7. Such an averaging is advantageously done over the number N_{P} of chirps composing the training word (or, more generally, over a plurality of successive elementary portions of duration T of the processed signal), and slidingly over Ng successive elementary portions of duration T (or, more generally, over several pluralities of successive elementary portions of duration T of the processed signal) so as to increase the probability of detecting the training word. The sequence T(k,p) is thus obtained, with k from 0 to M−1 and P from 1 to NB:

$$T ( k , p ) = {{\sum }_{j = p}}^{p + {N}_{p} - 1} {\vert \frac{Y ( k , j )}{{σ}_{ω}} \vert}^{2} \qquad ( Equation 8 )$$

with σ_{w}² the variance of the noise w(t). Such a variance is for example estimated during the periods wherein no useful signal is received.

The first piece of time synchronization information corresponds here to an estimation \hat{K} of the index K of the sample corresponding to the beginning of the training word of the frame transmitted by the object 100. Based on the sequence T(k,p), the estimation \hat{K} is given by:

$$\hat{K} = {argmax}_{p} ( M ( p ) ) \qquad ( Equation 9 )$$

with M(p) the function that represents the maximum values of T(k,p) for any p:

$$M ( p ) = {max}_{k} ( T ( k , p ) ) . \qquad ( Equation 10 )$$

In other embodiments, such an averaging over the number Nₚ of chirps composing the training word and/or slidingly over Ng successive elementary portions of duration T is not implemented. In this case the detecting of the beginning of the preamble of the frame corresponding to the signal with the strongest amplitude is done through simple searching for a maximum value among a sequence of delivered samples (e.g. the maximum value of the modulus of the samples in question) by a Fourier transform carried out on a multiplication of the signal received with an expected reference chirp (e.g. an expected reference chirp in the preamble of a data frame formed according to the LoRa® standard).

In other embodiments, the first piece of time synchronization information is alternatively estimated by a known method based on correlation such as for example the method described in the aforementioned patent document US 2014/064337 A1.

### Estimation of a Piece of Fractional Frequency Synchronization Information:

During a step E310, a piece of fractional frequency synchronization information representative of a frequency shift of the signal [symbol] (n) relative to a given frequency reference modulo the inverse of the symbol time T is estimated by implementing the first piece of time synchronization information.

More particularly, according to the notations introduced hereinabove in relation with the equation 6, it is supposed that the Doppler frequency f_{d}(t) also contains any frequency shift residue coming from a difference between local oscillators used to generate the emission and reception carrier frequencies. Moreover, such a Doppler frequency can be expressed in all generality as the sum of a complete portion (i.e., integer multiple of 1/T=B/M) and of a fractional portion (i.e. modulo 1/T=B/M). Thus, it is possible to write:

$${f}_{d} ( {nT}_{s} ) = u \frac{B}{M} + ϵ + ν \times {nT}_{s} \qquad ( Equation 11 )$$

with the variation rate of the Doppler frequency over time and ϵ the fractional portion that is sought to be estimated during the present step E310. It is supposed indeed realistically that the Doppler frequency remains constant over the duration of the signal considered to estimate ϵ (e.g., over the duration of the training word).

For example, supposing that the training word sₚ(t) (or synchronization word) of duration Tₚ positioned upstream from the useful data is comprised of Nₚ identical reference chirps, it is possible to use such a redundancy of information in order to obtain an estimation \hat{ϵ} of ϵ according to the equation:

$$\hat{ϵ} = \text{?} ( \frac{1}{2 π \times T} arg ( {{\sum }_{n = - \frac{N}{2}}}^{\frac{N}{2} - 1} y ( n , p ) {y}^{*} ( n , p + 1 ) ) ) \qquad ( Equation 12 )$$

$$With {I}_{test} = \{ ( \hat{K} + 1 ) , … , ( \hat{K} + {N}_{p} ) \} .$$

$$\text{?} \text{indicates text missing or illegible when filed}$$

Thus, during a step E310a, for each pair of successive elementary portions of a plurality of successive elementary portions of duration T starting at an instant according to the first piece of time synchronization information \hat{K}, the phase of a correlation value between, on the one hand, the signal [symbol] (n) considered over one of the elementary portions of the pair and, on the other hand, the signal [symbol] (n) considered on the other of the elementary portions of the pair is calculated. A set of corresponding correlation phases is thus obtained.

During a step E310b, the estimation of the piece of fractional frequency synchronization information, here corresponding to the estimation \hat{ϵ} of ϵ, is obtained by implementing an average of the phases of the set of correlation phases.

Thus, the estimation of the fractional portion \hat{ϵ} of the frequency shift of the signal relative to the frequency reference considered implements only the detection of a plurality of identical successive reference chirps (i.e., all having the same variation in phase). Thus, relative to the case where reference chirps having opposite variations in instantaneous frequency (i.e., an instantaneous frequency with positive and negative slopes) are required to allow for a good estimation of the synchronization parameters, a reduction in the length of the training word can be considered via the implementation of the present technique. Such a strategy makes it possible to improve the spectral efficiency of the communication system.

In other embodiments, the estimation of ϵ is reduced to the calculation of a single correlation value implementing a single pair of successive elementary portions of duration T starting at an instant according to the first piece of time synchronization information \hat{K}. In this case the absence of averaging makes it possible to simplify the implementation even though a loss in precision can occur.

### Estimating a Second Piece of Time Synchronization Information:

During a step E320, a second piece of time synchronization information representative of a time shift of the signal [symbol] (n) relative to the time reference considered is obtained by implementing the piece of fractional frequency synchronization information. In particular, the second piece of time synchronization information is estimated without taking account of the complete portion of the frequency shift of the signal [symbol] (n) relative to the frequency reference considered for the estimation of the piece of fractional frequency synchronization information \hat{ϵ} (i.e., the complete portion of a ratio between, on the one hand, the frequency shift in question and, on the other hand, the inverse of the symbol time T).

The second piece of time synchronization information comprises a second piece of fractional time synchronization information and a second piece of complete time synchronization information. The second piece of fractional time synchronization information is representative of the time shift of the signal [symbol] (n) relative to the time reference considered modulo the symbol time T. The second piece of complete time synchronization information is representative of the complete portion of the ratio between, on the one hand, the time shift of the signal [symbol] (n) relative to the time reference considered and, on the other hand, the symbol time T.

More particularly, during a step E320a, the second piece of fractional time synchronization information is estimated by implementing the piece of fractional frequency synchronization information.

To do this, during a step E321a, a complex exponential is applied to the signal [symbol] (n) so as to implement a transposition in frequency (derotation of the signal [symbol] (n)). More particularly, the signal [symbol] (n) is compensation for the estimation of the fractional portion \hat{ϵ} of the frequency shift. Moreover, so as to simplify the search for the complete portion of the second piece of time synchronization information described hereinbelow in relation with step E320c, the signal [symbol] (n) is also pre-synchronized by implementing the first piece of time synchronization information \hat{K}. The signal [symbol] _{ϵ}(n) partially resynchronized in frequency is thus obtained:

[symbol]

_{ϵ}(n)= [symbol] (n+(\hat{K}−1)N)e^{-j2πnT}^{ₛ}^{\hat{ϵ}} (Equation 13)

for n∈I₁={0, . . . , (Nₚ+P+1)N−1}. Note here that a block of N samples is considered before the instant \hat{K}T. This is due to our hypothesis that the time shift Δτ is uniformly distributed as a whole

$$( - \frac{T}{2} , \frac{T}{2} ] .$$

In other embodiments, the signal [symbol] (n) is not pre-synchronized by implementing the first piece of time synchronization information \hat{K}. In this case, the first piece of time synchronization information \hat{K} can for example be taken into account in the searching intervals implemented to estimate the fractional and complete portions of the second piece of time synchronization information as described hereinbelow. Such a taking into account makes it possible to simplify the estimation of the fractional and complete portions of the second piece of time synchronization information. In other terms, in these embodiments the sequences of samples of the signal [symbol] _{ϵ}(n) considered for the determination of the fractional and complete portions of the second piece of time synchronization information also correspond to elementary portions of duration T of the portion of the signal starting at an instant according to the first piece of time synchronization information \hat{K}.

Thus, returning to FIG. 3, during a step E322a, for at least one p-th sequence of samples of the signal [symbol] (n) partially resynchronized in frequency corresponding to an elementary portion of duration T of the portion of the signal starting at an instant according to said first piece of time synchronization information, an element-wise multiplication is implemented between, on the one hand, the sequence of samples of the signal [symbol] (n) and, on the other hand, a sequence of samples that are representative of the conjugated reference chirp (such as expected in the training word). Such a conjugated reference chirp is obtained by application of the modulation to a conjugated basic chirp an instantaneous frequency of which varies between the second instantaneous frequency and the first instantaneous frequency during a symbol time T. The multiplication delivers a sequence of multiplied samples.

During a step E323a, a Fourier transform of the sequence of multiplied samples delivers a sequence of transformed multiplied samples:

$${Y}_{e} ( k , p ) = \frac{1}{\sqrt{N}} {{\sum }_{n = 0}}^{N - 1} ( {y}_{e} ( n , p ) \text{?} ) \text{?} \qquad ( Equation 14 )$$

$$with p ∈ \{ 2 , … , {N}_{p} \} , and where {y}_{ϵ} ( n , p ) = {y}_{ϵ} ( n )$$

$$∀ n ∈ \text{?} pN , ( p + 1 ) N - 1 \text{?}$$

$$\text{?} \text{indicates text missing or illegible when filed}$$

If

$$\frac{Δ τ}{{T}_{s}} = υ + λ .$$

is defined, with v∈[0,N−1] and λ∈[0,1), the second piece of fractional time synchronization information corresponds to an estimation of the fractional portion λ. More particularly, λ is given by the distance at the frequency index of the peak of stronger amplitude in the sequence of multiplied samples Y_{ϵ}(k,p), i.e. by the distance at the index given by

$${argmax}_{k} ( \vert {Y}_{ϵ} ( k , p ) \vert ) .$$

In order to improve the estimation of the distance to the index in question, a binary method is for example implemented in order to search for the frequency index maximizing an interpolated function from transformed multiplied samples Y_{ϵ}(k,p). Preferably, the interpolated function is a sine function so as to model a continuous time Fourier transform, such a transform offering a time resolution that is arbitrarily fine. However other types of interpolations from transformed multiplied samples Y_{ϵ}(k,p) can be considered (splines, etc.).

For example, under the hypothesis that the interpolated function is concave over the search segment [a,b] for its maximum, such a dichotomy search can have the following form:

1) A number N=2^{p} of points [symbol] ₁=a< [symbol] ₂< . . . < [symbol] _{N}=b is considered, for example equidistant. For example, p is chosen such that

$$p = {log}_{2} ( \frac{b - a}{ψ} ) + 1.$$

The starting analysis interval is thus [a,b]=[ [symbol] ₁, [symbol] ₂_{^{p}}].
2) The interpolated function is estimated at the ends [symbol] ₁=a and [symbol] ₂_{^{p}}=b, and also at the two points at the middle of the analysis interval, i.e., [symbol] ₂_{^{p−1}} and [symbol] ₂_{^{p−1}}₊₁. If the maximum of the interpolated function evaluated for these four points is reached for one of the two points of the left half [ [symbol] ₁, [symbol] ₂_{^{p−1}}], this interval becomes the new analysis interval, otherwise the new analysis interval will be the interval [ [symbol] ₂_{^{p−1}}₊₁, [symbol] ₂_{^{p}}].
3) Returning to step 2) with the new analysis interval, the interpolated function is calculated for the new points associated with the new analysis interval and so on.

After p iterations, the two ends of the analysis interval will be two consecutive division points (spaced by a distance

$$\frac{b - a}{{2}^{p}} ) .$$

It is determined for which of the latter two points the value of the interpolated function is higher. The point corresponding to the higher value of the interpolated function is the solution sought.

Thus, such a method by dichotomy search implemented for each one of the Np sequences of transformed multiplied samples Y_{ϵ}(k,p) delivers a corresponding plurality of estimated time indexes \hat{λ}ₚ.

In this way, during a step E324a, the estimation \hat{λ} is obtained by averaging the estimated time indexes \hat{λ}ₚ:

$$\hat{λ} = \frac{1}{{N}_{p} - 1} {{\sum }_{p = 2}}^{{N}_{p}} {\hat{λ}}_{p} \qquad ( Equation 15 )$$

Thus, the estimation of the fractional portion of the time shift of the signal relative to the time reference considered is refined via the detecting of a plurality of identical successive reference chirps (i.e., all having the same variation in phase) as well as via the implementation of the calculation of the average.

However, in other embodiments, such an average is not implemented in order to reduce the calculation load.

In other embodiments, the second piece of fractional time synchronization information is alternatively estimated by application of a known method based on correlation, such as for example the method described in aforementioned patent document US 2014/064337 A1, with a sequence of samples of the signal [symbol] (n) partially resynchronized in frequency.

Returning to FIG. 3, during a step E320b, the second piece of complete time synchronization information is estimated by implementing the piece of fractional frequency synchronization information and the second piece of fractional time synchronization information.

More particularly, during a step E321b, a signal partially resynchronized in frequency and in time, [symbol] _{ϵ,λ}(n), is obtained by time translation of the signal [symbol] _{ϵ}(n) based on the second piece of fractional time synchronization information \hat{λ}:

[symbol]

_{ϵ,λ}(n)= [symbol] _{ϵ}(n+└\hat{λ}┐) (Equation 16)

with n∈I₁={0, . . . , (Nₚ+P+1)N−1}, and
where └\hat{λ}┐ represents the rounding of \hat{λ}.

In other embodiments, the Fourier transform given by the equation 14 is implemented at a sampling frequency that is lower than the sampling frequency 1/Ts=N/T considered until now. For example, the Fourier transform is implemented at the frequency 1/T (e.g., after decimation of the signal [symbol] _{ϵ}(n) by a factor M/N), which corresponds to M samples per symbol time T. In these embodiments, the signal [symbol] _{ϵ,λ}(n), sampled at the same initial frequency 1/Ts as the signal [symbol] _{ϵ}(n), is expressed as:

[symbol]

_{ϵ,λ}(n)= [symbol] _{ϵ}(n+└\hat{λ}×α┐) (Equation 17)

for n∈I₁={0, . . . , (Nₚ+P+1)N−1}, with

$$α = ⌊ \frac{N}{M} ⌋$$

the integer portion of N/M.

Returning to FIG. 3, during a step E322b, the estimation of the second piece of complete time synchronization information comprises a dichotomy search that is iterative over a time search interval that is updated at each iteration.

More particularly, based on the hypotheses made hereinabove as well as on the basis of the estimation of the first piece of time synchronization information and the second piece of fractional time synchronization information, it can be deduced that the beginning of the training word present in the processed signal is given by a sample, noted as \hat{n}ₛ, of the signal [symbol] _{ϵ,λ}(n) comprised in the interval [symbol] a×N,b×N [symbol] , with a=1/2 and b=3/2. The sample \hat{n}ₛ in question corresponds to the complete portion of the time shift of the processed signal relative to the time reference considered and therefore to the second piece of complete time synchronization information in the end.

Thus, the search for the sample \hat{n}ₛ consists in binarily reducing the interval [symbol] a×N,b×N [symbol] by changing a and b during the iterations based on the comparison of H(a) and H(b+(Nₚ−1)), with:

H(w)=max|Y_{ϵ,λ}(k,w)| (Equation 18)

In the equation 18, Y_{ϵ,λ}(k,w) is the Fourier transform of the signal [symbol] _{ϵ,λ}(n) multiplied by the sequence of samples of the conjugated reference chirp considered. In other terms, Y_{ϵ,λ}(k,w) is obtained by implementing the processing present in the equation 14 but applied to the signal [symbol] _{ϵ,λ}(n) instead of signal [symbol] _{ϵ}(n) for n∈ [symbol] ωN,(ω+1)N−1 [symbol] . Thus, for a given iteration of the present dichotomy search:
if H(a) is greater than or equal to (respectively greater than) H(b+(Nₚ−1)), the value b−(b−a)/2 is substituted for b and \hat{n}ₛ is attributed the value a×N
if H(a) is less than (respectively less than or equal to) H(b+(Nₚ−1)), the value a+(b−a)/2 is substituted for a and is attributed the value b×N.
   For example, the dichotomy search is stopped after a predetermined number of iterations, e.g., after

$${N}_{it} = {log}_{2} ( \frac{( b - a ) N}{ψ} ) + 1$$

iterations, with ψ the desired precision over \hat{n}ₛ.

In the aforementioned embodiments wherein the signal [symbol] (n) is not pre-synchronized by implementing the first piece of time synchronization information \hat{K} (cf. step E321a hereinabove), the first piece of time synchronization information \hat{K} can be for example taken into account in the searching intervals implemented in the iterative dichotomy search so as to simplify the search for \hat{n}ₛ. In these embodiments as well as in the embodiment of FIG. 3, the dichotomy search implements, for a given iteration corresponding to a given time search interval:
a first Fourier transform of a sequence of samples of the signal partially resynchronized in frequency and in time corresponding to an elementary portion of duration T of the signal [symbol] (n) starting at a first instant according to the first limit a of the given time search interval and of the first piece of time synchronization information \hat{K}, the first Fourier transform delivering a first sequence of transformed samples; and
a second Fourier transform of a sequence of samples of the signal partially resynchronized in frequency and in time corresponding to an elementary portion of duration T of the signal [symbol] (n) starting at a second instant according to the second limit b of the given time search interval and of the first piece of time synchronization information \hat{K}, the second Fourier transform delivering a second sequence of transformed samples.

The given iteration delivers a time search interval updated according to the given time search interval and first and second extreme values among the first and second sequences of transformed samples as described hereinabove. Likewise, the value attributed to \hat{n}ₛ as well as the number of iterations to be considered follow the principles described hereinabove.

At the end of the implementation of the different steps of the method for synchronizing according to the invention, the first piece of time synchronization information \hat{K}, the piece of fractional frequency synchronization information \hat{ϵ}, the second piece of fractional time synchronization information \hat{λ} and the second piece of complete time synchronization information \hat{n}ₛ are available to resynchronize during a step E330 the processed signal received by the receiver implementing the method for synchronizing according to the invention. Such a resynchronized signal [symbol] (n) is expressed for example according to:

[symbol]

(n)= [symbol] _{ϵ,λ}(n+\hat{n}ₛ+NₚN+nₛᵢ) ∀n∈I={0, . . . ,PN−1} (Equation 19)

where

$${n}_{si} = \frac{{T}_{si}}{{T}_{s}} .$$

represents the number of samples in the retaining period.

The data conveyed by the useful portion of the signal [symbol] (n) can then be estimated according to the principles disclosed in patent document EP 2 449 690 B1 for example.

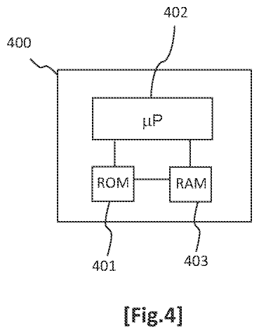

In relation with FIG. 4 an example of the device structure 400 is now presented making it possible to implement some of the steps of the method for synchronizing of FIG. 3 according to an embodiment of the invention.

The device 400 comprises a live memory 403 (for example a RAM memory), a processing unit 402 equipped for example with a processor and controlled by a computer program stored in a read-only memory 401 (for example a ROM memory or a hard drive). At the initialization, the code instructions of the computer program are for example loaded into the live memory 403 before being executed by the processor of the processing unit 402.

This FIG. 4 shows only one particular manner, among several possible, of carrying out the device 400 so that it carries out certain steps of the method for synchronizing according to the invention (according to any of the embodiments and/or alternatives described hereinabove in relation with FIG. 3). Indeed, these steps can be carried out indifferently on a reprogrammable calculation machine (a PC computer, a DSP processor or a microcontroller) executing a program comprising a sequence of instructions, or on a dedicated calculation machine (for example a set of logic gates such as a FPGA or an ASIC, or any other hardware module).

In the case where the device 400 is carried out with a reprogrammable calculation machine, the corresponding program (i.e. the sequence of instructions) can be stored in a removable storage medium (such as for example a CD-ROM, a DVD-ROM, a USB key) or not, this storage medium able to be read partially or entirely by a computer or a processor.

In certain embodiments, the device 400 is included in the base station 110, for example in a receiver of the base station 110.

In certain embodiments, the device 400 is included in the object 100, for example in a receiver of the object 100.

In certain embodiments, the device 400 is included in equipment for monitoring the radiocommunications network, for example in a receiver of the equipment in question.

1-11. (canceled)

12. A method for synchronizing a signal received by a communication receiver from an estimation of at least one piece of synchronization information of the signal, the signal comprising a plurality of chirps among M chirps, an s-th chirp among the M chirps being associated with a modulation symbol of rank s of a constellation of M symbols, s being an integer from 0 to M−1,
the s-th chirp resulting from a modulation of a basic chirp of which an instantaneous frequency varies between a first instantaneous frequency and a second instantaneous frequency during a symbol duration time T,
the modulation corresponding, for a modulation symbol of rank s, to a circular permutation of a variation pattern of said instantaneous frequency over the symbol duration time T, obtained by a time shift of s times an elementary time duration Tc, such that M*Tc=T,
the method comprising, for a portion of the signal that is representative of at least one chirp of the plurality of chirps:
estimating a first piece of time synchronization information that is representative of a time shift in the signal relative to a given time reference;
estimating a piece of fractional frequency synchronization information that is representative of a frequency shift in the signal relative to a given frequency reference modulo an inverse of the symbol duration time T, by implementing the first piece of time synchronization information;
estimating at least one second time synchronization information that is representative of a time shift of the signal relative to the given time reference by implementing the piece of fractional frequency synchronization information; wherein a portion of the signal comprising a plurality of successive elementary portions of a symbol duration time T starting at an instant according to the first piece of time synchronization information, for at least one pair of successive elementary portions of the plurality of successive elementary portions, the estimation of the piece of fractional frequency synchronization information implements a calculation of a correlation phase, of a correlation value between the signal considered over one of the at least one pair of successive elementary portions and the signal considered over another one of the at least one pair of successive elementary portions, the piece of fractional frequency synchronization information being according to the correlation phase; and wherein the estimation of the at least one second time synchronization information comprises a derotation of the portion of the signal according to the piece of fractional frequency synchronization information, delivering a portion of the signal partially resynchronized in frequency.

13. The method of claim 12, wherein the estimation of the at least one second time synchronization information comprises an estimation, implementing the piece of fractional frequency synchronization information, of a second piece of fractional time synchronization information that is representative of a time shift of the signal relative to the given time reference modulo the symbol duration time T.

14. The method of claim 13, wherein the estimation of the at least one second time synchronization information comprises an estimation, implementing the piece of fractional frequency synchronization information and the second piece of fractional time synchronization information of a complete time synchronization information that is representative of a second piece of complete portion of a ratio between the time shift and the symbol duration time T.

15. The method of claim 14, wherein the plurality of successive elementary portions of duration T comprises at least three elementary portions; and wherein, for each pair of successive elementary portions among the at least three elementary portions, the estimation of the piece of fractional frequency synchronization information implements the calculation of the correlation phase, delivering a corresponding set of correlation phases, and the piece of fractional frequency synchronization information being according to an average of phases of the set of correlation phases.

16. The method of claim 13, wherein the estimation of a second piece of fractional time synchronization information comprises, for at least one sequence of samples of the portion partially resynchronized in frequency corresponding to an elementary portion of duration T of the portion of the signal starting at an instant according to the first piece of time synchronization information:
an element-wise multiplication between the at least one sequence of samples of the portion partially resynchronized in frequency and, a sequence of samples that is representative of a conjugated reference chirp obtained by application of the modulation to a conjugated basic chirp an instantaneous frequency of which varies between the second instantaneous frequency and the first instantaneous frequency during the symbol duration time T, the element-wise multiplication delivering a sequence of multiplied samples;
a Fourier transform of the sequence of multiplied samples delivering a sequence of transformed multiplied samples; and
the second piece of fractional time synchronization information being according to a sample of stronger amplitude among the sequence of transformed multiplied samples.

17. The method of claim 16, wherein the estimation of the second piece of fractional time synchronization information implements a method for a dichotomy search of a frequency index maximizing an interpolated function from the transformed multiplied samples.

18. The method of claim 17, wherein the element-wise multiplication and the Fourier transform are implemented for a plurality of sequences of successive samples of the portion partially resynchronized in frequency, each corresponding to an elementary portion of duration T of the portion of the signal starting at an instant according to the first piece of time synchronization information, delivering at least one corresponding plurality of sequences of transformed multiplied samples; and wherein the dichotomy search is implemented for each sequence of transformed multiplied samples of the plurality of sequences of transformed multiplied samples and delivers a plurality of corresponding time indexes, and the second piece of fractional time synchronization information being according to an average of the time indexes of the plurality of corresponding time indexes.

19. The method of claim 14, wherein an estimation of a second complete time synchronization information comprises a time translation of the portion partially resynchronized in frequency according to the second piece of fractional time synchronization information, delivering a portion of the signal partially resynchronized in frequency and in time.

20. The method of claim 19, wherein the estimation of the second complete time synchronization information comprises a dichotomy search that is iterative over a time search interval that is updated at each iteration, the dichotomy search implementing, for a given iteration corresponding to a given time search interval:
a first Fourier transform of a sequence of samples of the portion partially resynchronized in frequency and in time corresponding to an elementary portion of duration T of the portion of the signal starting at a first instant according to a first limit of the given time search interval and of the first piece of time synchronization information, the first Fourier transform delivering a first sequence of transformed samples;
a second Fourier transform of a sequence of samples of said portion partially resynchronized in frequency and in time corresponding to an elementary portion of duration T of the portion of the signal starting at a second instant according to a second limit of the given time search interval and of the first piece of time synchronization information, the second Fourier transform delivering a second sequence of transformed samples,
the given iteration delivering a time search interval updated according to the given time search interval and an extreme value among the first and the second sequences of transformed samples,
the dichotomy search implemented for a predetermined number of iterations delivering a final time search interval, and
the second complete time synchronization information being according to at least one limit of the final time search interval.

21. A computer program product executable a processor-based computer, comprising program code instructions to implement the method of claim 12.

22. A device for synchronizing a signal received by a communication receiver from an estimation of at least one piece of synchronization information of the signal, the signal comprising a plurality of chirps among M chirps, an s-th chirp among the M chirps being associated with a modulation symbol of rank s of a constellation of M symbols, s being an integer from 0 to M−1,
the s-th chirp resulting from a modulation of a basic chirp of which an instantaneous frequency varies between a first instantaneous frequency and a second instantaneous frequency during a symbol duration time T;
the modulation corresponding, for the modulation symbol of rank s, to a circular permutation of a variation pattern of the instantaneous frequency over the symbol duration time T, obtained by a time shift of s times an elementary time duration Tc, such that M*Tc=T;
the device comprising a processor configured to perform, for a portion of the signal that is representative of at least one chirp of the plurality of chirps:
an estimation, implementing said first piece of time synchronization information of a first piece of time synchronization information that is representative of a time shift in the signal relative to a given time reference;
an estimation of a piece of fractional frequency synchronization information that is representative of a frequency shift in such signal relative to a given frequency reference modulo the inverse of said symbol duration time T;
wherein the processor is configured to perform:
an estimation, implementing the piece of fractional frequency synchronization information, of at least one second piece of time synchronization information that is representative of a time shift of the signal relative to the given time reference; wherein the portion of the signal comprising a plurality of successive elementary portions of duration T starting at an instant according to the first piece of time synchronization information, for at least one pair of successive elementary portions of the plurality, said estimation of the piece of fractional frequency synchronization information implements a correlation calculation of a phase of a correlation value between the signal considered over one of the successive elementary portions of the at least one pair of successive elementary portions and the signal considered over another of the successive elementary portions of the at least one pair of successive elementary portions, the piece of fractional frequency synchronization information being according to the correlation phase; and wherein the estimation of the at least one second piece of time synchronization information comprises a derotation of the portion of the signal according to the piece of fractional frequency synchronization information, delivering a portion of the signal partially resynchronized in frequency.
